(19) United States
(12) Patent Application Publication
(10) Pub. No.: US 2012/0169624 A1
(43) Pub. Date: Jul. 5, 2012

(54) STAGED ACCESS POINTS

(75) Inventors: Jonathan Garn, North Bend, WA (US); Yee-Shian Lee, San Diego, CA (US); April A. Reagan, Kenmore, WA (US); Harish Sripad Kulkarni, Redmond, WA (US)

(73) Assignee: MICROSOFT CORPORATION, Redmond, WA (US)

(21) Appl. No.: 13/083,227

(22) Filed: Apr. 8, 2011

Related U.S. Application Data
(60) Provisional application No. 61/429,715, filed on Jan. 4, 2011.

(51) Int. Cl. G06F 3/041

(52) U.S. Cl. 345/173

(57) ABSTRACT

Various embodiments are described herein that relate to determining an intent of a user to initiate an action on an interactive display system. For example, one disclosed embodiment provides a method of initiating an action on an interactive display device, the interactive display device including a touch-sensitive display. In this example, the method comprises displaying an initiation control at a launch region of the display, receiving an initiation input via the initiation control, displaying a confirmation target in a confirmation region of the display in response to receiving the initiation input, receiving a confirmation input via the confirmation target, and performing an action responsive to the confirmation input.

### CROSS REFERENCE TO RELATED APPLICATIONS

This application claims priority to U.S. Provisional Patent Application Ser. No. 61/429,715, titled “Two-stage Access Points,” and filed on Jan. 4, 2011, the entirety of which is hereby incorporated herein by reference for all purposes.

### BACKGROUND

Interactive display systems, such as surface computing devices, include a display screen and a touch sensing mechanism configured to detect touches on the display screen. Various types of touch sensing mechanisms may be used, including but not limited to optical, capacitive, and resistive mechanisms. An interactive display system may utilize a touch sensing mechanism as a primary user input device, thereby allowing the user to interact with the device without keyboards, mice, or other such traditional input devices.

### SUMMARY

Various embodiments are described herein that relate to determining an intent of a user to initiate an action on an interactive display system. For example, one disclosed embodiment provides a method of initiating an action on an interactive display device, the interactive display device comprising a touch-sensitive display. The method comprises displaying an initiation control at a launch region of the display, receiving an initiation input via the initiation control, displaying a confirmation target in a confirmation region of the display in response to receiving the initiation input, receiving a confirmation input via the confirmation target, and performing an action responsive to the confirmation input.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an embodiment of an interactive display device.

FIG. 2 shows a flowchart illustrating an embodiment of a method of initiating an action on an interactive display device.

FIG. 3 shows an embodiment of a user interface comprising a launch region and initiation control.

FIG. 4 shows the embodiment of FIG. 3 displaying a confirmation target after receiving an initiating input.

FIG. 5 shows the embodiment of FIG. 3 after receiving a confirmation input.

### DETAILED DESCRIPTION

As mentioned above, an interactive display device may utilize a touch-sensitive display as a primary input device. Thus, touch inputs, which may include gesture inputs and hover inputs (i.e. gestures performed over the surface of the display), may be used to interact with all aspects of the device, including applications and the operating system.

In some environments, such as where an interactive display device has a table-like configuration with a horizontal display, inadvertent touches may occur. The severity of the impact of such a touch input may vary, depending upon how the interactive display device interprets the inadvertent input. For example, an inadvertent touch in a “paint” program may result in the drawing of an inadvertent line or other such minor, reversible action that is not disruptive to other users, while an inadvertent touch that results in closing or restarting an application or operating system shell may be very disruptive to the user experience.

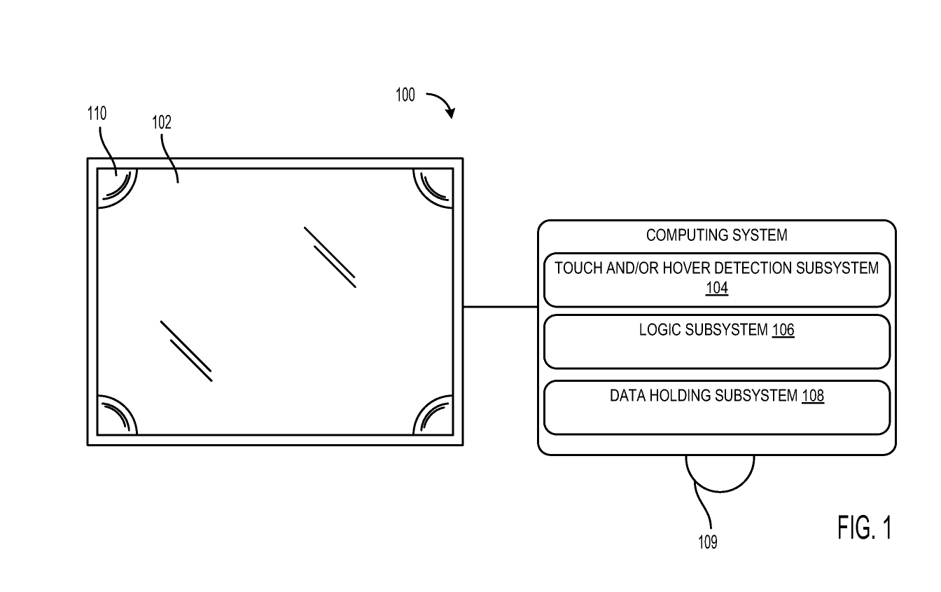

Accordingly, various embodiments are disclosed herein that relate to staged initiation of actions on an interactive display device to help avoid inadvertent touches that result in the execution of disruptive actions. Prior to discussing these embodiments, an example interactive display device 100 is described with reference to FIG. 1. Interactive display device 100 includes a display 102 configured to display images and to receive touch inputs. Non-limiting examples of display 102 include emissive display panels such as plasma displays and OLED (organic light emitting device) displays, modulating display panels such as liquid crystal displays (LCD), projection microdisplays such as digital micromirror devices (DMDs) or LCD microdisplays, and cathode ray tube (CRT) displays. It will be understood that various other hardware elements not depicted in FIG. 1, such as projectors, lenses, light guides, etc., may be used to produce an image for display on display 102. It further will be understood that interactive display device 100 may be any suitable type of device, including but not limited to a mobile device such as smart phone or portable media player, slate computer, tablet computer, personal computer, laptop computer, surface computer, television system, etc.

Interactive display device 100 further includes a touch and/or hover detection system 104 configured to detects touch inputs and/or hover inputs on or near display 102. As mentioned above, the touch and/or hover detection system 104 may utilize any suitable mechanism to detect touch and/or hover inputs. For example, an optical touch detection system may utilize one or more cameras to detect touch inputs, e.g., via infrared light projected onto the display screen and/or via a frustrated total internal reflection (FTIR) mechanism. Likewise, an optical touch and/or hover detection system 104 may utilize a sensor-in-pixel display panel in which image sensor pixels are interlaced with image display pixels. Other non-limiting examples of touch and/or hover detection system 104 include capacitive and resistive touch detection systems.

Interactive display device 100 also includes a logic subsystem 106 and a data-holding subsystem 108. Logic subsystem 106 is configured to execute instructions stored in data-holding subsystem 108 to implement the various embodiments described herein. Logic subsystem 106 may include one or more physical devices configured to execute one or more instructions. For example, logic subsystem 106 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 106 may include one or more processors that are configured to execute software instructions. Additionally or alternatively, logic subsystem 106 may include one or more hardware or firmware logic machines configured to execute hardware or firmware instructions. Processors of logic subsystem 106 may be single core or multicore, and the programs executed thereon may be configured for parallel, distributed, or other suitable processing. Logic subsystem 106 may optionally include individual components that are distributed throughout two or more devices, which may be remotely located and/or configured for coordinated processing. One or more aspects of logic subsystem 106 may be virtualized and executed by remotely accessible networked computing devices configured in a cloud computing configuration.

Data-holding subsystem 108 may include one or more physical, non-transitory, devices configured to hold data and/or instructions executable by logic subsystem 106 to implement the herein described methods and processes. When such methods and processes are implemented, the state of the data-holding subsystem 108 may be transformed (e.g., to hold different data).

Data-holding subsystem 108 may include removable computer media and/or built-in computer-readable storage media and/or other devices. Data-holding subsystem 108 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 108 may include devices with one or more of the following characteristics: volatile, nonvolatile, dynamic, static, read/write, read-only, random access, sequential access, location addressable, file addressable, and content addressable. In some embodiments, logic subsystem 106 and data-holding subsystem 108 may be integrated into one or more common devices, such as an application specific integrated circuit or a system on a chip.

FIG. 1 also shows an aspect of data-holding subsystem 108 in the form of removable computer-readable storage media 109, which may be used to store and/or transfer data and/or instructions executable to implement the herein described methods and processes. Removable computer-readable storage media 109 may take the form of CDs, DVDs, HD-DVDs, Blu-Ray Discs, EEPROMs, and/or floppy disks and/or other magnetic media, among others.

As mentioned above, an inadvertent touch input may be interpreted by an interactive display device as a command to perform an action. For example, in some embodiments, an interactive display device 102 may take the form of a table or desk. As such, inadvertent touches may easily occur, for example, where a user rests a hand or elbow on the display. If such an inadvertent input occurs over a user interface control used for a disruptive action, such as a re-start or exit action, the inadvertent touch may be disruptive to the user experience.

As a more specific example, in the embodiment of FIG. 1, the interactive display device 100 comprises a user interface having a plurality of active regions 110 arranged at the corners of the display 102. Active regions 110 represent regions of display 102 in which a touch input is configured to trigger the execution of specific application and/or operating system control actions. For example, a touch input within active region 110 may cause an application to re-start or exit. While active regions 110 are depicted in the corners of display 102 in the embodiment of FIG. 1, it will be appreciated that such active regions 110 may have any other suitable location.

Because the unintended execution of a restart command (for example) would disrupt the user experience, interactive display device 102 utilizes a staged activation sequence to confirm a user's intent to perform such an action. In this manner, a user making an unintentional touch may avoid triggering the action. While the embodiments described herein utilize a two-stage activation sequence, it will be understood that other embodiments may utilize three or more stages.

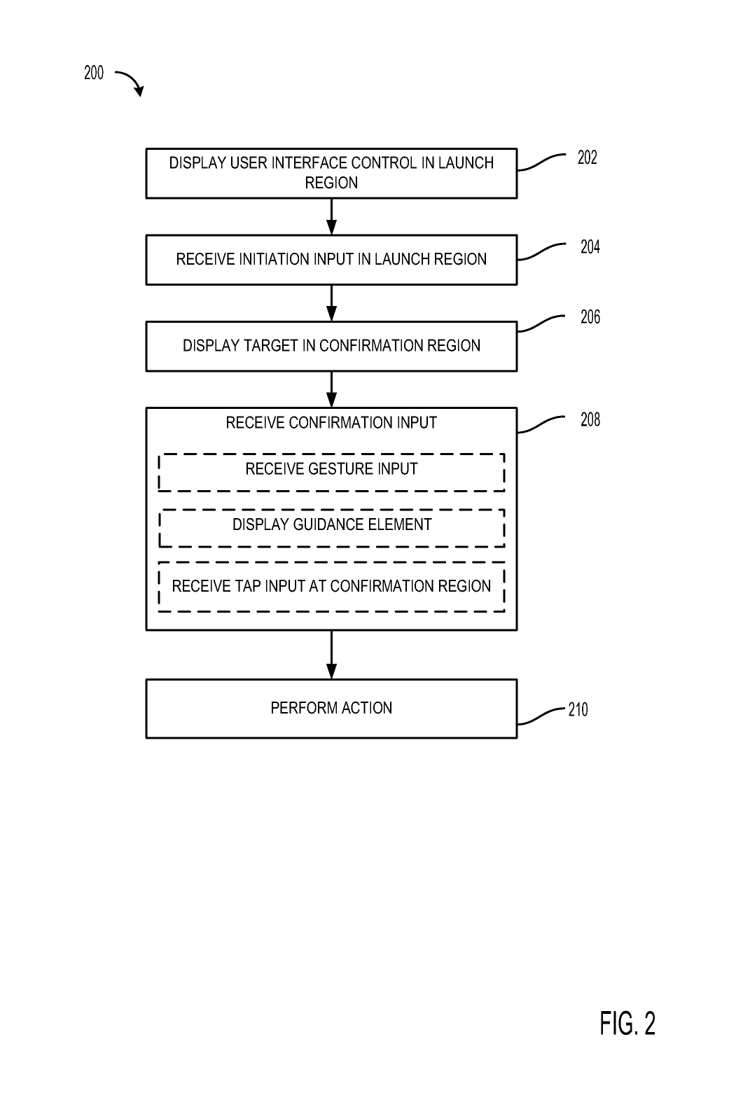

FIG. 2 shows a flowchart illustrating an embodiment of a method 200 of initiating an action at an interactive display device, wherein an initiation input received at a launch region of the display and a confirmation input received at a confirmation region of the display are used to confirm user intent. While method 200 is described below with reference to the embodiment shown in FIG. 1, it will be appreciated that method 200 may be performed using any suitable hardware and software.

Method 200 comprises, at 202, displaying an initiation control, such as an icon, in a launch region of the display and, at 204, receiving an initiation input in the launch region, wherein the initiation input comprises a touch interaction with the initiation control. It will be understood that the initiation control may be displayed persistently in the launch region, or may be displayed when a touch is detected in the launch region. The launch region comprises a portion of the display, such as active region 110 of FIG. 1, configured to detect an initiation input during the first stage of a staged sequence.

An initiation input made over the initiation control may be intended or inadvertent. Thus, the interactive display device does not perform the action until a confirmation input received. Thus, method 200 next comprises, at 206, displaying a confirmation target, such as a target icon and/or target text, in the confirmation region. The display of the confirmation target may signal to a user that the initiation touch has been recognized, and the target text may indicate the action that will be performed if a confirmation input is received. The term “confirmation target” as used herein signifies any user interface element with which a user interacts to confirm intent to perform a previously initiated action.

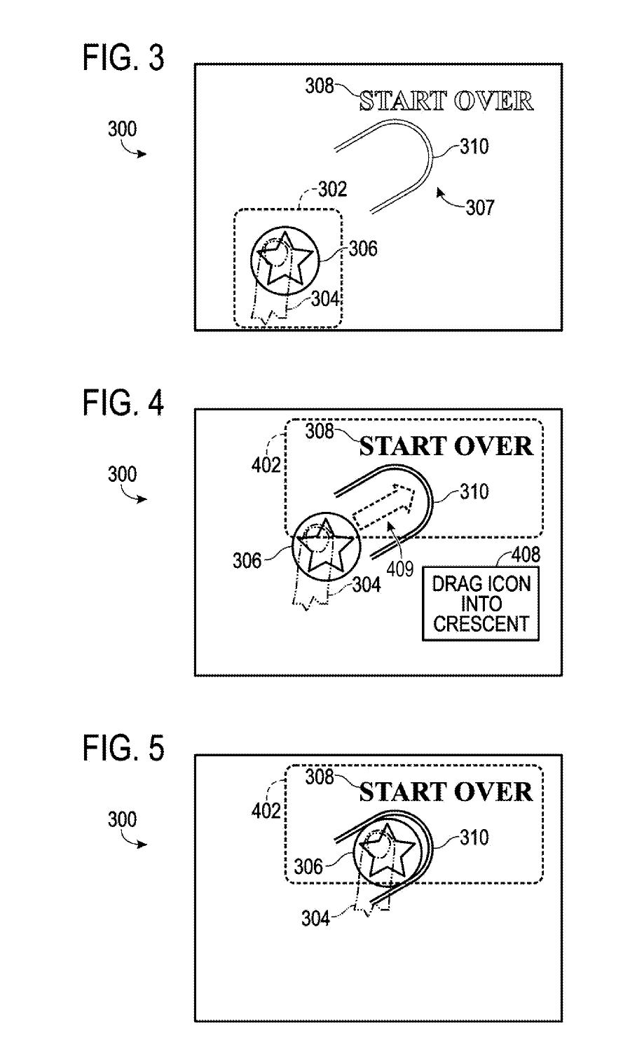

FIG. 3 shows an embodiment of a user interface 300 including a launch region 302 with an initiation control 306 in the form of an icon displayed therein. As explained above, it will be understood that the icon, or another suitable initiation control, may be displayed persistently in the launch region, or may be displayed when a touch is detected in the launch region. As shown in FIG. 3, a finger 304 is positioned over control 306. It will be understood that finger 304 is shown for example purposes only, and is not intended to be limiting, as an initiation control may be activated in any suitable way. Thus, while discussed in the context of touch input (including the touch, gesture, and hover inputs described above), the embodiments described herein may be used with input received from other suitable user input devices, such as 3-D cameras, cursor control devices such as trackballs, pointing sticks, styluses, mice, etc.

FIG. 3 also depicts, in ghosted form, a confirmation target 307 comprising target text 308 and a target icon 310 with which a user may interact to confirm intent. These elements are shown in ghosted form to indicate that they may be invisible or have a reduced visual presence when not activated, and may be displayed at full intensity once an initiation input is detected within launch region 302. Further, in some embodiments, display of confirmation target 307 may include suitable animation and/or sound effects configured to attract a user's attention. Thus, a user who may be unfamiliar with initiating actions at the interactive display device may find that the animation and/or sound effects provide helpful clues about how to initiate an action. Further, such animation and/or sound effects may alert a user to an inadvertent interaction with initiation control 306. In embodiments of method 200 performed on a mobile device, suitable haptic sensations may accompany display of confirmation target 307.

In the depicted embodiment, the target text 308 indicates the action to be performed if confirmed. As shown in the embodiment illustrated in FIG. 3, target icon 310 has a complementary shape to the icon in the launch region, and is configured to allow a user to drag the icon from the launch region into an interior of the target icon to confirm intent. It will be appreciated that the complementary shapes of the launch region icon and the target icon may help to indicate to a user the nature of the gesture to be performed. It further will be appreciated that the specific appearances and locations of the icons in the embodiment of FIG. 3 is presented for the purpose of example, and that the initiation and confirmation user interface elements may have any other suitable appearances and locations.

Returning to FIG. 2, method 200 next comprises, at 208, receiving a confirmation input. In some embodiments, the confirmation input may comprise a gesture moving the icon in the launch region toward the confirmation target. For example, in some embodiments, the confirmation input may include a gesture dragging the icon from the launch region to an interior of the complementary icon. Additionally or alternatively, in some embodiments, the confirmation input may comprise a tap input received within a confirmation region defined around the confirmation target, e.g. over the target text. If the confirmation input is received within a predetermined confirmation time interval after recognition of the initiation input, the device will perform the associated action. Otherwise, the staged activation sequence will time out and terminate without performing the relevant action.

The confirmation time interval may have any suitable duration. Suitable durations include, but are not limited to, durations suitable to allow a new user to understand the nature of the confirmation input, yet not to occupy display space for undesirably long time periods. While FIG. 4 depicts a single confirmation target, it will be appreciated that some embodiments may include a plurality of confirmation targets, each of which may correspond to a different action.

Returning to FIG. 2, in some embodiments, a training user interface element may be displayed prior to or while receiving the confirmation input to instruct the user how to perform the confirmation input. For example, FIG. 4 shows a text box 408 comprising text instructing the user to “Drag Icon into Crescent” to perform the confirmation input. A training element also or alternatively may comprise a graphical element illustrating, for example, a path to be traced to perform a confirmation gesture. For example, FIG. 4 also shows another example training element including a display of a directional arrow 409 configured to guide the user's performance of the confirmation input. It will be appreciated that text box 408 and directional arrow 409 are non-limiting examples of training elements, and that other suitable training elements and or combinations of training elements may be displayed, or that no training element may be displayed at all. In some embodiments, a display one or more training elements may include suitable animation and/or ghosting effects configured to enhance the visual cue provided to the user.

Such training elements may be displayed based on various gesture input characteristics, including, but not limited to, gesture speed and/or direction characteristics. For example, a training element may be displayed for gesture judged to be slower than a predetermined threshold speed or to have an incorrect path, as a less experienced user, possibly unsure about how the icon should be manipulated, may have a comparatively slower gesture input relative to more experienced and more confident users.

In some embodiments, a display of confirmation target 307 and/or initiation control 306 provide the function offered by one or more training elements. For example, an appearance of confirmation target 307 and/or initiation control 306 may be varied as the user performs the confirmation gesture, such variation being configured to indicate the user's progress toward successful performance of the gesture. It will be understood that suitable haptic cues, audible cues and/or visual animation cues may accompany a display of a training element.

As mentioned above, other touch inputs than a dragging gesture may be utilized as confirmation inputs. For example, as mentioned above, receiving a confirmation input may comprise receiving a tap input in a confirmation region. As a more specific example, an experienced user may elect to first tap control 306 and then tap target text 308 or target icon 310 to confirm the action the user intends the device to perform, rather than performing the dragging confirmation input. This combination may be comparatively faster for the user relative to a tap-and-drag sequence and thus may appeal to more skilled users. In response, in some embodiments, the display may show movement of initiation control 306 into target icon 310, to provide a visual cue that the confirmation input was performed successfully. In some embodiments, other suitable haptic cues, audible cues and/or visual animation cues may be provided to indicate successful performance of the confirmation input, while in some other embodiments, no cues may be provided other than cues accompanying performance of the initiated action (for example, a shutdown animation sequence accompanying shutdown of the device).

Once the interactive display device receives confirmation input, method 200 comprises, at 210, performing the action. For example, FIG. 5 schematically shows the user interface after initiation control 306 dragged to the interior of target icon 310 by finger 304. Responsive to this confirmation input, the interactive display device will perform the “Start Over” action indicated by target text 308.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of initiating an action at a interactive display device including a display, the method comprising:
displaying an initiation control at a launch region of the display;
receiving an initiation input via the initiation control;
in response to receiving the initiation input, displaying a confirmation target in a confirmation region of the display;
receiving a confirmation input via the confirmation target; and
performing an action responsive to the confirmation input.

2. The method of claim 1, wherein receiving the confirmation input comprises receiving a gesture input dragging a user interface icon toward the confirmation target.

3. The method of claim 2, wherein the gesture input comprises dragging the user interface icon into an interior of a complementary user interface icon of the confirmation target.

4. The method of claim 1, further comprising performing the action only if the confirmation input is received within a predetermined confirmation time interval.

5. The method of claim 1, wherein receiving the confirmation input comprises receiving a tap input via the confirmation target.

6. The method of claim 1, further comprising displaying a training element in response to receiving the initiating input.

7. The method of claim 6, wherein the training element is displayed responsive to one or more of a gesture speed and a gesture direction characteristic.

8. An interactive display device, comprising:
a display;
a touch and/or hover detection subsystem configured to detect touches and/or near-touches over the display;
a data-holding subsystem; and
a logic subsystem configured to execute instructions stored in the data-holding subsystem, the instructions configured to:
display an initiation control in a launch region of the display,
receive an initiation input via the initiation control,
receive a confirmation input in a confirmation region of the display; and
perform an action responsive to the confirmation input.

9. The device of claim 8, further comprising instructions executable to display a confirmation target in response to receiving the initiation input.

10. The device of claim 8, further comprising instructions executable to display a training element in response to one or more of a gesture speed and a gesture direction characteristic.

11. The device of claim 8, further comprising instructions executable to perform the action only if the confirmation input is received within a predetermined confirmation time interval.

12. The device of claim 8, wherein the confirmation input comprises a tap input in the confirmation region of the display.

13. The device of claim 12, wherein the initiation input comprises one or more of a touch interaction and a hover interaction with the initiation control.

14. The device of claim 8, wherein the instructions are executable to receive the confirmation input as a gesture input dragging a user interface icon toward the confirmation region.

15. The device of claim 14, wherein the gesture comprises an input dragging the user interface icon into an interior of a complementary user interface icon in the confirmation region.

16. The device of claim 16, wherein the initiation input comprises one or more of a touch interaction and a hover interaction with the initiation control.

17. A computer-readable medium comprising instructions stored thereon that are executable by a computing device to:
display an initiation control comprising an icon in a launch region of a display;
receive an initiation input via the initiation control;
in response to receiving the initiation control, display a confirmation target in a confirmation region of the display, the confirmation target comprising a target icon with a shape complementary to a shape of the icon in the launch region;
receive a confirmation input in the confirmation region of the display; and
if the confirmation input is received within a predetermined confirmation time interval, perform an action responsive to the confirmation input.

18. The interactive display device of claim 17, wherein the confirmation input comprises a gesture dragging the icon from the launch region to an interior of the complementary icon.

19. The interactive display device of claim 17, wherein the confirmation input comprises a tap input received within the confirmation region.

20. The interactive display device of claim 19, wherein the confirmation input is received over target text displayed in the confirmation region.
